(19) United States
(12) Patent Application Publication
(10) Pub. No.: US 2011/0153232 A1
(43) Pub. Date: Jun. 23, 2011

(54) GAS PRESSURE MONITORING SYSTEM AND GAS-INSULATED ELECTRIC APPARATUS

(75) Inventor: Takashi ITO, Chiyoda-ku (JP)

(73) Assignee: Mitsubishi Electric Corporation, Chiyoda-ku (JP)

(21) Appl. No.: 12/792,356

(22) Filed: Jun. 2, 2010

(30) Foreign Application Priority Data
Dec. 17, 2009 (JP) 2009-286452

(51) Int. Cl. G01M 3/16

(52) U.S. Cl. 702/51

(57) ABSTRACT

In a conventional gas pressure monitoring system that detects a gas leak inside the hermetic container using temperatures measured by the temperature sensor provided outside the hermetic container, there exist uncertain temperature differences between actual temperatures inside the hermetic container and measured temperatures. Thus it is difficult to obtain from a pressure measured inside the hermetic container, an equivalent pressure converted to one at a predetermined temperature, so that it is not possible to early detect a gas leak. By removing the influence of the uncertain differences between temperatures inside and outside the hermetic container, from characteristic-curve slopes obtained from time-series measurements in pressure and temperature during predetermined periods at intervals of 24 hours, it becomes possible to obtain an equivalent pressure inside the hermetic container with a high accuracy, to detect a gas leak at early stages.

### TECHNICAL FIELD

The present invention relates to a gas pressure monitoring system that monitors a leak of gas enclosed in a gas-insulated electric apparatus such as a gas-insulated switchgear and relates to a gas-insulated electric apparatus provided therewith.

### BACKGROUND ART

In a conventional gas pressure monitoring system, a gas pressure sensor and a temperature sensor are provided in a hermetic container of a gas-insulated electric apparatus, and the pressure and temperature measured by the sensors are used to calculate an equivalent pressure corresponding to a temperature determined in advance, using the gas state equation or Beattie-Bridgeman equation, and change in the equivalent pressure is monitored to recognize gas leakage of the gas-insulated electric apparatus (for example, refer to Patent document 1: Japanese Patent Laid-Open No. 1986(S61)-227327).

The temperature in the hermetic container provided for the gas-insulated electric apparatus depends on changes in the external environment and is affected by the thermal conductivity of the container's outer shell and gas convection in the container, so that the temperature fluctuates with a little difference from changes in the external environment. Thus, an actual temperature in the hermetic container largely depends on a portion where the temperature sensor is provided. For example, between a case in which the sensor is provided outside the hermetic container and a case in which the sensor is provided inside thereof, the temperature sensor quite differently responds to changes in the external environment. Therefore, the equivalent pressure calculated from the temperature and the pressure measured by the temperature sensor and the pressure sensor both provided at arbitrary portions of the gas pressure monitoring system also fluctuates, and it is difficult to compensate the fluctuation, causing a difficulty in recognizing gas leakage or the like.

To reduce effects of the changes in the external environment, there has been a system proposed in which the temperature and the pressure are measured by a temperature sensor and a pressure sensor provided for a hermetic container at a predetermined time early in the morning (for example, at five o'clock) when the temperature less fluctuates, so as to obtain an equivalent pressure in the hermetic container (for example, refer to Patent document 2: Japanese Patent Laid-Open No. 1991(H03)-222613).

However, the equivalent pressure obtained, as described above, from the temperature and the pressure at a predetermined time largely varies over days, having a problem in its accuracy. Even if trying to improve the accuracy in the equivalent pressure using its trend, it takes three months to accumulate, for example, 100 equivalent-pressure measurements. Thus, this cannot provide early detection of gas leakage.

### SUMMARY OF THE INVENTION

The present invention is made to solve the problem described above, and aims to obtain a pressure monitoring system that can early detect gas leakage of the gas-insulated electric apparatus without depending on portions where a temperature sensor is provided.

A gas pressure monitoring system according to the present invention includes a pressure sensor that measures pressure inside a hermetic container; a temperature sensor that measures temperature of the hermetic container; a memory device that stores in time-series, pressure measurements and temperature measurements obtained by the pressure sensor and the temperature sensor; and a calculation unit that is capable of calculating a slope of a characteristic curve expressing a relationship between the pressure measurements and the temperature measurements stored in the memory device on a predetermined period basis.

### EFFECT OF THE INVENTION

According to a gas pressure monitoring system configured as described above, the system calculates a slope of a characteristic curve expressing a relationship between pressure and temperature for each of predetermined periods, so that the system can precisely detect changes in charging pressure of the gas enclosed in the hermetic container, enabling early detection of gas leakage in a gas-insulated electric apparatus.

### BRIEF DESCRIPTION OF DRAWINGS

FIG. 1 is a configurational diagram of a gas-insulated electric apparatus of Embodiment 1;

FIG. 2 is a block diagram of an arithmetic processing apparatus provided in a gas pressure monitoring system of Embodiment 1;

FIG. 3 is a graph that shows characteristic curves with respect to the pressure of a charged gas used in Embodiment 1;

FIG. 4 is a correlation diagram between the charging pressure and the characteristic curve's slope in Embodiment 1;

FIG. 5 is a graph that shows temporal variation of temperature measurements sensed by temperature sensors of Embodiment 1;

FIG. 6 is a graph that shows a characteristic curve sensed by a first temperature sensor of Embodiment 1;

FIG. 7 is a graph that shows a characteristic curve sensed by a second temperature sensor of Embodiment 1;

FIG. 8 is a graph that shows temporal variation of the difference between first and second temperature measurements sensed by the first and second temperature sensors of Embodiment 1;

FIG. 9 is a graph that shows a characteristic curve sensed by the first temperature sensor of Embodiment 1; and

FIG. 10 is a graph that shows a characteristic curve sensed by the second temperature sensor of Embodiment 1.

### DESCRIPTION OF THE PREFERRED EMBODIMENT

### Embodiment 1

Embodiment 1 according to the present invention will be explained in detail below, using figures.

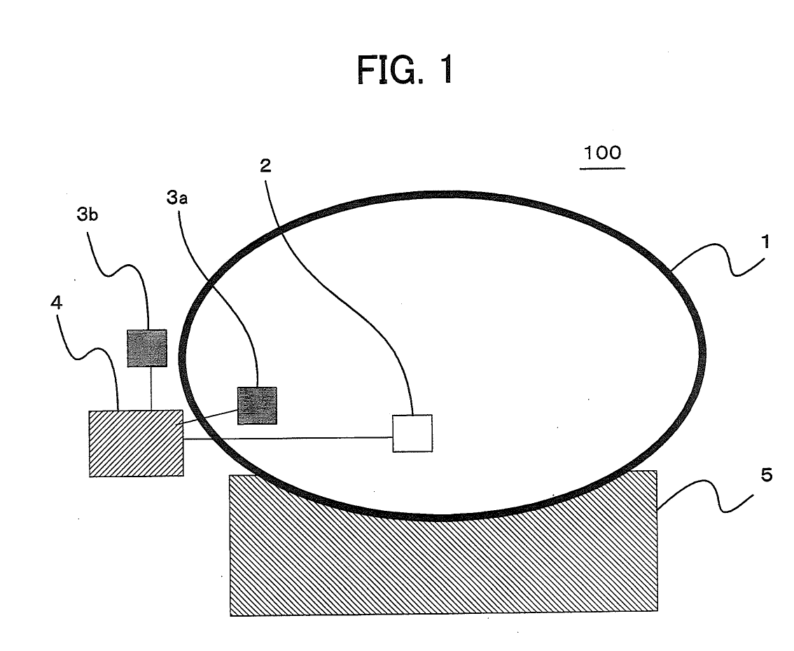

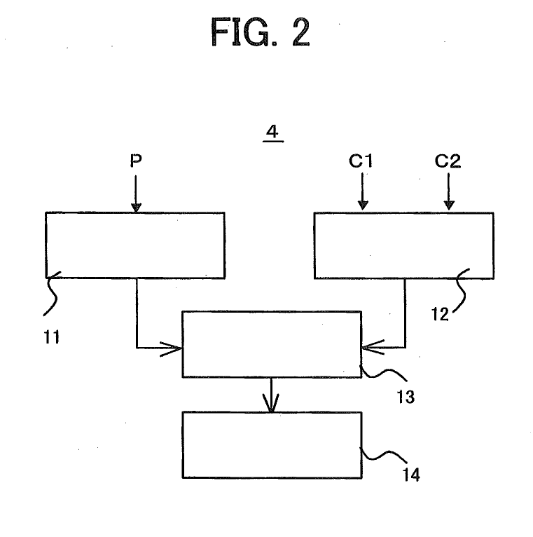

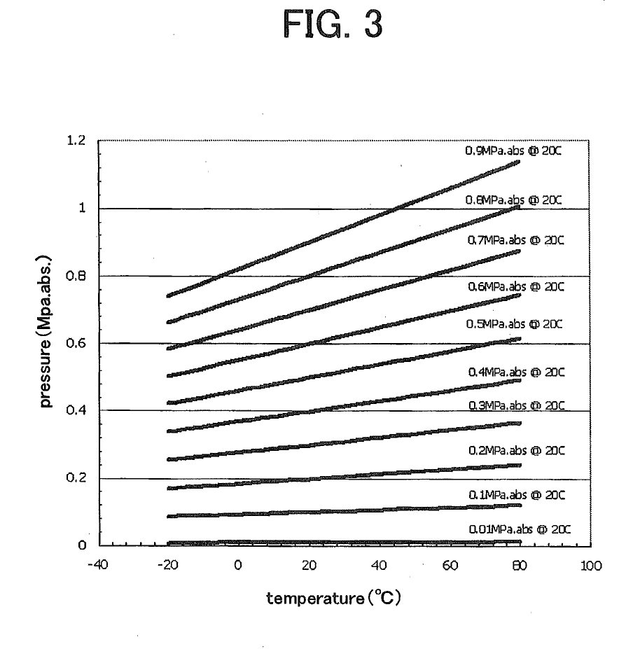

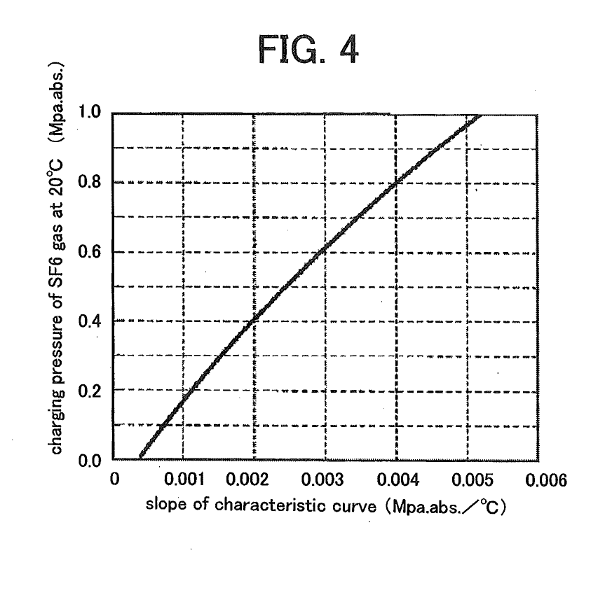

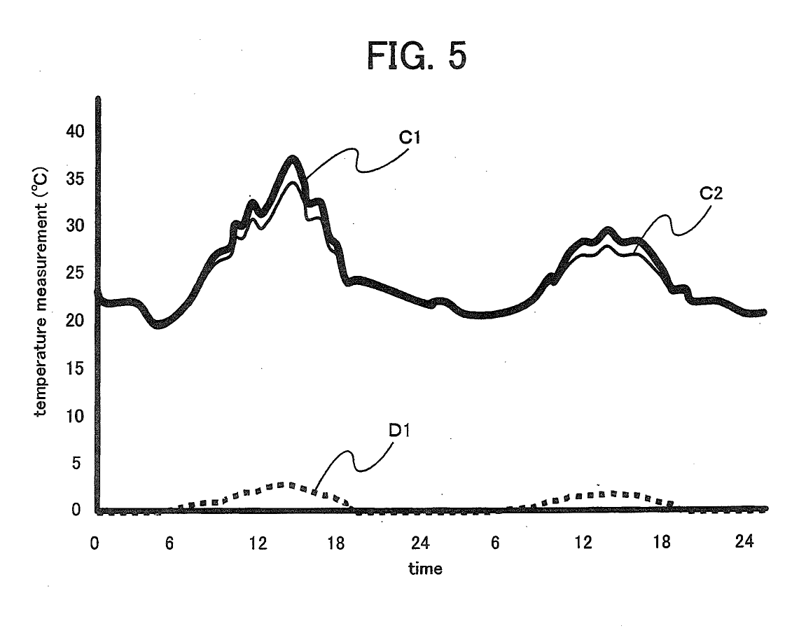

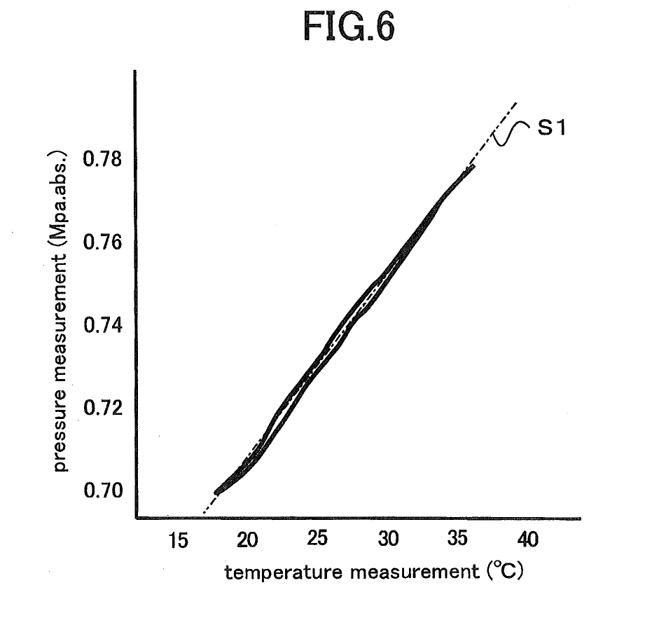

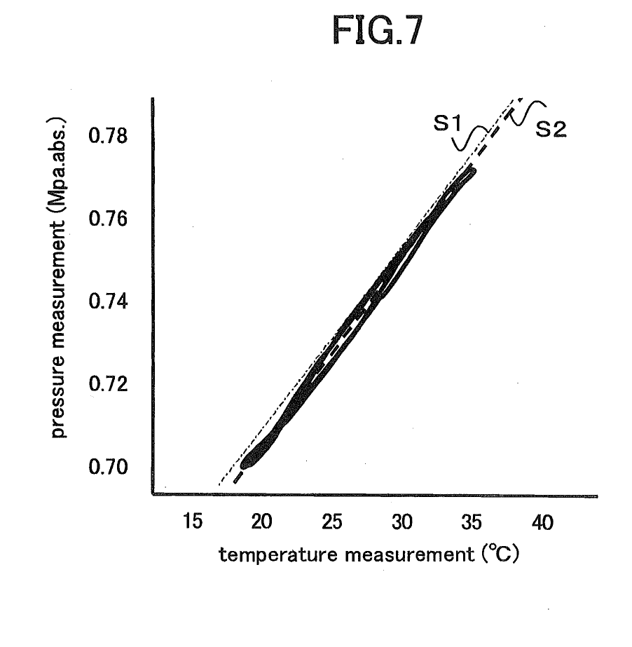

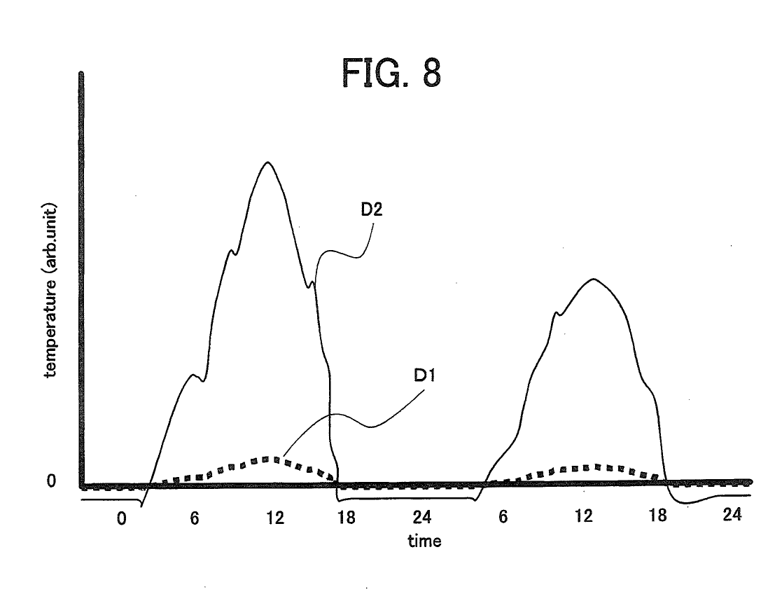

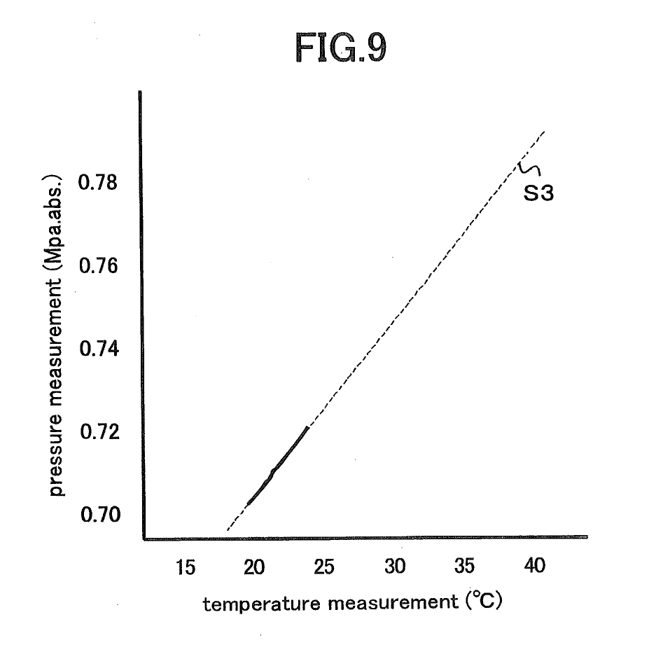

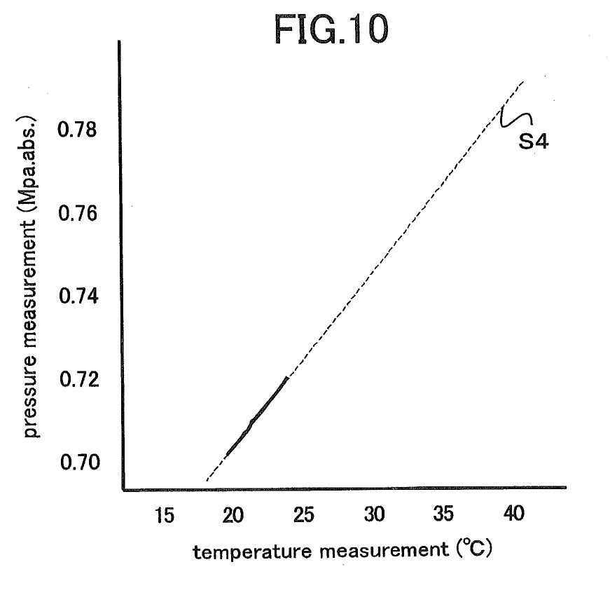

FIG. 1 is a configurational diagram of a gas-insulated electric apparatus provided with a gas pressure monitoring system according to Embodiment 1 of the present invention; FIG. 2 is a block diagram of an arithmetic processing apparatus provided in the gas pressure monitoring system; FIG. 3 is a graph that shows characteristic curves each of which corresponds to the charging pressure (a pressure in a container at a predetermined temperature) of an SF6 gas enclosed in the gas pressure monitoring system; FIG. 4 a correlation diagram between the charging pressure of the SF6 gas at 20° C. and slopes of the characteristic curves mentioned above; FIG. 5 is a graph that shows temporal change of temperature measurements sensed by temperature sensors of the gas pressure monitoring system; FIG. 6 is a graph that shows a characteristic curve sensed by a first temperature sensor; FIG. 7 is a graph that shows a characteristic curve sensed by a second temperature sensor; FIG. 8 a graph that shows temporal change of the difference between first and second temperature measurements sensed by the first and second temperature sensors; FIG. 9 is a graph that shows a characteristic curve sensed by the first temperature sensor; and FIG. 10 is a graph that shows a characteristic curve sensed by the second temperature sensor. In addition, components designated as the same numerals in the figures are identical or equivalent components.

As shown in FIG. 1, a hermetic container 1 of the gas-insulated electric apparatus 100 is charged with a SF6 gas, which is excellent in insulation performance and is not illustrated, and is provided with the gas pressure monitoring system 200 that includes a pressure sensor 2, the first temperature sensor 3a and the second temperature sensor 3b for monitoring the state of the SF6 gas. The pressure sensor 2 and the first temperature sensor 3a are placed inside the hermetic container 1. Note that the pressure sensor 2 is not necessarily placed inside the hermetic container 1, and it may be placed inside an unillustrated pipe or the like that is in communication with the hermetic container. In short hand, the pressure sensor may be placed anywhere as long as it can measure the pressure inside the hermetic container 1.

Outside the hermetic container 1, the second temperature sensor 3b is placed. With the pressure sensor 2, the first temperature sensor 3a, and the second temperature sensor 3b, obtained are a pressure measurement P inside the hermetic container and temperature measurements C1 and C2 inside and outside the container. The pressure measurement P and the temperature measurements C1 and C2 that are obtained are transmitted to an arithmetic processing apparatus 4 for calculations detailed later.

In addition, FIG. 1 shows that the hermetic container 1 is placed on a fixing base 5.

FIG. 2 shows that the arithmetic processing apparatus 4 is provided with a pressure storage device 11 that records, in time series as required, pressure measurements P inside the hermetic container 1 transmitted from the pressure sensor 2, and a temperature storage device 12 that records, in time series as required, temperature measurements C1 and C2 inside and outside the hermetic container, transmitted from the first and second temperature sensors 3a and 3b.

The pressure measurements P and the temperature measurements C1 and C2 that are recorded as required are transmitted to a calculation unit 13, in which a slope of a characteristic curve showing the pressure inside the hermetic container 1 which changes depending on temperature changes inside or outside the hermetic container 1 is calculated in a predetermined manner detailed later, and then the calculation results are displayed on a display unit 14 in a time-transitional manner.

Hereinafter, explanations will be made about a characteristic curve of an SF6 gas which is enclosed in the hermetic container and is monitored by the gas pressure monitoring system of Embodiment 1.

Generally, the pressure of the SF6 gas enclosed in the hermetic container is calculated at a given temperature, using a gas state equation based on Boyle-Charle's law, or an equation having a higher accuracy such as Beattie-Bridgeman equation expressed as Equation 1 shown below.

P=R·T·(V+B)/V²−A/V² Equation 1

where,

P is pressure (atm.abs.),

V is molar volume (liter/mol),

T is temperature (K),

R is the gas constant of 0.08207 (liter atm.abs/mol K), and

A and B are expressed as Equation 2 and Equation 3 shown below.

A=15.78·(1−0.1062/V) Equation 2

B=0.366·(1−0.1236/V) Equation 3

FIG. 3 is a graph that shows characteristic curves (results of calculation according to Equation 1) of the SF6 gas, which express how its pressure changes according to temperature change inside the hermetic container under respective conditions that the container is charged with the SF6 gas at various charging pressures with its inner temperature being uniformly kept at a common temperature of 20° C.

In each of the characteristic curves, the pressure increases linearly as the temperature increases.

However, the respective slopes of the characteristic curves are different from each other depending on the charging pressure when the hermetic container is charged with the SF6 gas. The larger the charging pressure, the larger the slope.

From this fact, it would be understood that the charging pressure of the SF6 gas in the hermetic container at the temperature 20° C. can be calculated by obtaining the slope of the characteristic curve of the SF6 gas.

In other words, an increase or decrease in the amount of the SF6 gas enclosed in the hermetic container can be known from the slope of the gas's characteristic curve, without calculating its equivalent pressure.

For example, when the SF6 gas leaks gradually from inside the hermetic container according to the secular change, the slope of the characteristic curve monotonically decreases as time elapses.

Thus, it becomes theoretically possible to recognize a gas leak state of the hermetic container through measuring changes in the slope of the characteristic curve.

FIG. 4 is a graph which shows charging pressures of the SF6 gas at 20° C. that are calculated according to Equation 1 with respect to characteristic curves' slopes at 20° C.

The slope of a measured characteristic curve is applied to FIG. 4 so as to obtain a charging pressure, and then by observing the charging pressure in time series, a charging pressure's change in the hermetic container can be estimated, which theoretically makes it possible to easily recognize a gas leak state.

Therefore, for monitoring the charging pressure change in time series, it is not inevitably required to perform calculation using Equations 1 through 3.

Hereinafter, an explanation will be made about a method used by the calculation unit 13 in the arithmetic processing apparatus 4 to obtain characteristic curve's slopes.

FIG. 5 is a graph that exemplifies in time series, first and second temperature measurements C1 and C2 measured by the first and the second temperature sensors 3a and 3b provided inside and outside the hermetic container 1 and differences D1 between the first and second temperature measurements C1 and C2 in a case where a gas-insulated electric apparatus 100 with no gas leak, of Embodiment 1 according to the present invention, is placed in an outdoor environment, in the open air, for two days (fine, but occasionally cloudy during the days).

FIGS. 6 and 7 are characteristic curves that show relations between the pressure measurement P inside the hermetic container 1, and the first and second temperature measurements C1 and C2 measured by the first and second temperature sensors 3a and 3b provided inside and outside the hermetic container 1. Both the characteristic curve with temperature measured inside the hermetic container 1 and that outside the container exhibit a hysteresis. It can be seen that a plurality of pressure measurements P exist (spread) for a temperature measurement C indicated by the sensor 3 provided for the hermetic container 1, depending on measurement timing.

In other words, this means that a conventional measuring method in which an equivalent pressure is obtained in the use of a temperature measurement C and a pressure measurement P obtained at predetermined timing does not give a precise charging pressure.

On the other hand, although the characteristic curve itself includes a hysteresis characteristic, a method of obtaining a slope S of the characteristic curve uses a lot of pressure measurements P corresponding to a lot of temperature measurements C (by averaging), giving a relatively precise value.

Therefore, when a charging pressure inside the hermetic container 1 is to be obtained, the method of obtaining from the characteristic curve's slope S gives more precise pressure than the conventional method of obtaining from an equivalent pressure.

The area of the hysteresis loop of the characteristic curve obtained by the first temperature sensor 3a provided inside the hermetic container 1 is narrower than that of the hysteresis loop of the characteristic curve obtained by the second temperature sensor 3b.

From this fact, it can be seen that a characteristic curve obtained by the first temperature sensor 3a inside the hermetic container 1 gives less spread pressure measurements P for a temperature measurement to thereby obtain a more precise slope S of the characteristic curve, resultantly giving a more precise charging pressure inside the hermetic container 1. However, because hysteresis still exists in the characteristic curve described above, the slope S (obtained by an averaging operation in the use of pressure measurements P with respect to temperature measurements C1 and C2) of the characteristic curve would include an uncertain error.

An explanation will be made about why hysteresis exists in the characteristic curve described above.

FIG. 8 is a graph in which the difference D1 between the first and second temperature measurements C1 and C2 given in FIG. 5 is shown over time, and a magnified difference D2 obtained from the difference D1 by magnifying the temperature axis used for D1 is superimposed on the difference D1. During a time period from about 6 o'clock in the morning to about 19 o'clock in the evening, the temperature inside the hermetic container 1 is several degrees higher than the outside temperature.

On the other hand, during the rest of the period—from about 19 o'clock to about 6 o'clock in the next morning, the temperature difference between those inside and outside of the hermetic container 1 is almost constant. Many other measurement results (not shown in the figures) show that such 24-hour periodic change is repeated everyday, except for bad weather days such as rainy days.

In short hand, when it is bright outside, the temperature difference between inside and outside the hermetic container 1 becomes large, and when it becomes dark, the temperature difference converges to a constant value.

Such a temperature difference between inside and outside the hermetic container 1 gives hysteresis to the characteristic curves.

FIGS. 9 and 10 are characteristic curves obtained during a time period between about 19 o'clock to about 6 o'clock in the next morning, showing relations between pressure measurements P inside the hermetic container 1 and the first and second temperature measurements C1 and C2 measured by the first and second temperature sensors 3a and 3b provided inside and outside the hermetic container 1. Slopes S3 and S4 of the characteristic curves are almost equal. In addition, their characteristic curves have little hysteresis.

Therefore, it can be seen that a characteristic curve slope S with a very high repeatability can be obtained by using a characteristic curve expressing a relation between the pressure measurements P and either one of the first and second temperature measurements C1 and C2 obtained by the first and second temperature sensors 3a and 3b provided inside and outside the hermetic container 1, in which those measurements are made during a period (for example, from about 21 o'clock to about 3 a.m. in the middle of the night) when the temperature difference between the temperature measurements C1 and C2 varies within a predetermined small range.

In addition, in Embodiment 1, although the first temperature sensor of the gas pressure monitoring system is placed inside the hermetic container, it may be placed, similarly to the second temperature sensor, outside the hermetic container. This is because even though both the first and second temperature sensors are placed outside the hermetic container, the temperature difference between the first and second temperature measurements can be obtained to determine a small-variation period.

In that case, it is just necessary that the temperature sensors are placed indifferent positions, for example, a sunny place for the first and a shady place for the second.

Furthermore, because the characteristic curve slopes S obtained during the small-variation period such as midnight hours are almost equal as described above without depending on the first and second temperature sensors 3a and 3b provided inside and outside the hermetic container 1, it should be especially noted that the charging pressure of the hermetic container 1 can be obtained without considering where to place the temperature sensor 3.

In other words, because the characteristic curve hardly includes an uncertain error by using pressure measurements P and temperature measurements C measured during a period when the temperature difference between the first and second temperature measurements C1 and C2 varies within a predetermined range, or a period to be considered as a small-variation period, a charging pressure inside the hermetic container 1 can be obtained with a higher accuracy, using temperature measurements from one temperature sensor 3 provided at any position.

From the reason described above, it can be seen that by measuring during the small-variation period or a predetermined period, the conventional method which obtains an equivalent pressure using the gas state equation or the like can be improved to obtain a more precise charging pressure.

More specifically, by obtaining equivalent pressures in time series from pressure measurements P and temperature measurements C measured during the small-variation period or the predetermined period and then averaging the time-series equivalent pressures to get a charging pressure, the charging pressure becomes to have a high accuracy.

However, in a method in which equivalent pressures are used, because there is a constant temperature difference between temperature measurements C1 and C2 measured by first and second temperature sensors 3a and 3b provided inside and outside the hermetic container, the obtained equivalent pressures vary depending on the position of the sensor to be used.

Therefore, it is considered that it is hard to obtain a precise charging pressure using equivalent pressures.

However, because there is a high repeatability for equivalent pressures obtained by using individual temperature sensors 3, a change in equivalent pressure which varies in conjunction with the charging pressure inside the hermetic container 1 can be measured with a high accuracy.

The methods described above, to obtain characteristic-curve slopes S and to obtain equivalent pressure are accordingly adopted for the calculation unit 13.

The calculation unit 13 in the arithmetic processing apparatus 4 calculates a slope S of a characteristic curve or an equivalent pressure with a high precision, using pressure measurements P and temperature measurements C that are measured in time series during a small-variation period or a predetermined period and recorded in the pressure storage device 11 and the temperature storage device 12.

A sampling interval for the pressure measurements P and the temperature measurements C to be used for calculating a characteristic-curve slope S or an equivalent pressure is set to be, for example, 24 hours, so that a characteristic curve slope S or an equivalent pressure is calculated using pressure measurements P and temperature measurements C measured during every-24-hours small variation period or a predetermined period. Then, the characteristic curve slopes S or the equivalent pressures calculated every 24 hours are displayed in time series on a display unit 14.

By checking time change of the characteristic-curve slopes S or equivalent pressures displayed in time series on the display unit 14, the charging pressure changes over days inside the hermetic container 1 of the gas-insulated electric apparatus 100 can be recognized.

Then, if the characteristic curve slope S or the equivalent pressure tends to decrease day by day, the existence of a gas leak is confirmed.

Therefore, the display unit 14 may be provided with a determining unit not shown in the figures, which compares temporal changes in characteristic-curve slopes or equivalent pressures calculated by the calculation unit in time series for predetermined periods to alarm when a gas leak develops beyond a predetermined level.

In addition, it is also possible to make the calculation unit 13 obtain a current charging pressure from a characteristic curve slope S.

As has been explained above, because a system according to Embodiment 1 of the present invention obtains a characteristic curve with no hysteresis, using pressure measurements P and temperature measurements C that are measured during a small-variation period or a predetermined period when its temperature sensor measures temperature without depending on its positioned place, the system can precisely recognize time-series variations in charging pressure inside a hermetic container or can precisely measure the charging pressure, bringing an effect that a gas leak can be recognized early and precisely.

[Reference numeral]

| | | | |
|---|---|---|---|
| 1 | hermetic container | 2 | pressure sensor |
| 3a | first temperature sensor | 3b | second temperature |
| | | | sensor |
| 4 | arithmetic processing apparatus | | |
| 11 | pressure storage device | 12 | temperature storage |
| | | | device |
| 13 | calculation unit | 14 | display unit |
| 100 | gas-insulated electric apparatus | | |

What is claimed is:

1. A gas pressure monitoring system comprising:
a pressure sensor that measures pressure inside a hermetic container;
a temperature sensor that measures temperature of the hermetic container;
a memory device that stores in time-series, pressure measurements and temperature measurements obtained by the pressure sensor and the temperature sensor; and
a calculation unit that is capable of calculating a slope of a characteristic curve expressing a relationship between the pressure measurements and the temperature measurements stored in the memory device on a predetermined period basis.

2. A gas pressure monitoring system comprising:
a pressure sensor that measures pressure inside a hermetic container;
a temperature sensor that measures temperature of the hermetic container;
a memory device that stores in time-series, pressure measurements and temperature measurements obtained by the pressure sensor and the temperature sensor; and
a calculation unit that is capable of calculating equivalent pressures from pressure measurements and temperature measurements stored in the memory device for predetermined time periods to calculate an average of the calculated equivalent pressures.

3. The gas pressure monitoring system according to claim 1, wherein the calculation unit uses pressure measurements and temperature measurements that are recorded during night hours.

4. The gas pressure monitoring system according to claim 2, wherein the calculation unit uses pressure measurements and temperature measurements that are recorded during night hours.

5. A gas pressure monitoring system, comprising:
a pressure sensor that measures pressure inside a hermetic container;
first and second temperature sensors that measure temperature of different portions of the hermetic container;
a memory device that stores in time series pressure measurements obtained by the pressure sensor, and first and second temperature measurements obtained by the first and second temperature sensors; and
a calculation unit that calculates a slope of a characteristic curve of pressure measurements vs. first temperature measurements, or pressure measurements vs. second temperature measurements, measured during each of small-variation periods during which the difference between the first and second temperature measurements stored in the memory device is within a predetermined range.

6. A gas pressure monitoring system, comprising:
a pressure sensor that measures pressure inside a hermetic container;
first and second temperature sensors that measure temperature of different portions of the hermetic container;
a memory device that, in time series, stores pressure measurements obtained by the pressure sensor, and first and second temperature measurements obtained by the first and the second temperature sensor; and
a calculation unit that calculates an equivalent pressure from pressure measurements and first temperature measurements, or pressure measurements and second temperature measurements, that are obtained during each small-variation period during which the differences between the first and the second temperature measurements stored in the memory device are within a predetermined value, and then calculates an average value of calculated equivalent pressures.

7. The gas pressure monitoring system according to claim 5, wherein the first temperature sensor is placed inside the hermetic container, and the second temperature sensor is placed outside the hermetic container.

8. The gas pressure monitoring system according to claim 6, wherein the first temperature sensor is placed inside the hermetic container, and the second temperature sensor is placed outside the hermetic container.

9. A gas-insulated electric apparatus comprising the gas pressure monitoring system according to claim 1.

10. A gas-insulated electric apparatus comprising the gas pressure monitoring system according to claim 2.

11. A gas-insulated electric apparatus comprising the gas pressure monitoring system according to claim 3.

12. A gas-insulated electric apparatus comprising the gas pressure monitoring system according to claim 4.

13. A gas-insulated electric apparatus comprising the gas pressure monitoring system according to claim 5.

14. A gas-insulated electric apparatus comprising the gas pressure monitoring system according to claim 6.

15. A gas-insulated electric apparatus comprising the gas pressure monitoring system according to claim 7.

16. A gas-insulated electric apparatus comprising the gas pressure monitoring system according to claim 8.
